(19) United States
(12) Patent Application Publication
(10) Pub. No.: US 2020/0302387 A1
(43) Pub. Date: Sep. 24, 2020

(54) INFORMATION PROCESSING METHOD AND INFORMATION PROCESSING SYSTEM

(71) Applicant: Panasonic Intellectual Property Management Co., Ltd., Osaka (JP)

(72) Inventors: Eiichi NAITO, Kyoto (JP); Keisuke IWATA, Osaka (JP)

(21) Appl. No.: 16/819,791

(22) Filed: Mar. 16, 2020

(30) Foreign Application Priority Data
Mar. 20, 2019 (JP) 2019-053300

(51) Int. Cl. G06Q 10/08

(52) U.S. Cl. CPC G06Q 10/0836; G06Q 10/0838; G06Q 10/08355; G06Q 10/08345; G06Q 10/0837

(57) ABSTRACT

An information processing method includes, when information indicating absence of a consignee at a delivery address of a package being delivered is obtained, information related to candidates for a receiving agent who acts to receive the package is obtained, information indicating a position of the package and information indicating the delivery address of the package are obtained, a redelivery cost required for redelivery of the package to the delivery address is calculated based on a positional relationship between the position of the package and the delivery address, a receiving agent delivery cost required for a delivery of the package to the delivery address via each candidate is calculated based on information related to the candidate, the candidate with the receiving agent delivery cost less than the redelivery cost is selected as the receiving agent, and a request for acting to receive the package is notified to the receiving agent.

### CROSS REFERENCE TO RELATED APPLICATION

The present application is based on and claims priority of Japanese Patent Application No. 2019-053300 filed on Mar. 20, 2019. The entire disclosure of the above-identified application, including the specification, drawings and claims is incorporated herein by reference in its entirety.

### FIELD

The present disclosure relates to an information processing method and an information processing system related to package delivery.

### BACKGROUND

In recent years, the cases where a consignee of a delivered package is absent have been increasing, leading to an increased redelivery cost required for redelivery by a carrier. In order to address this problem, a technique for reducing the redelivery has been studied. For example, Patent Literature (PTL) 1 discloses a mail order product shop delivery system in which a consignee designates a receiving agency, such as a convenience store convenient for the consignee to receive a package so that the consignee is capable of receiving the package at the designated receiving agency. In such a mail order product shop delivery system, the delivery management server of a carrier searches for the closest receiving agency with the designated receiving address as a search key, identifies appropriate receiving agent candidates, and prompts the person ordering to determine the desired receiving agency from among the candidates.

### CITATION LIST

### Patent Literature

[PTL 1] Japanese Patent Publication No. 5096963

### SUMMARY

### Technical Problem

However, in the mail order product shop delivery system disclosed in PTL 1, the consignee has to determine by himself or herself whether to receive the package at the receiving agency. Additionally, the consignee has to designate the receiving agency, and further has to go to the receiving agency to pick up the package. As described, the mail order product shop delivery system disclosed in PTL 1 has a problem that effort from the consignee is required.

The present disclosure provides an information processing method and an information processing system which are capable of reducing the delivery cost, while delivering a package to the delivery address without any effort from the consignee of the package.

### Solution to Problem

An information processing method according to one aspect of the present disclosure is an information processing method executed by a computer. The information processing method includes: when information indicating absence of a consignee at a delivery address of a package being delivered is obtained, obtaining, for each of one or more candidates for a receiving agent who acts to receive the package, information related to the candidate; obtaining information indicating a position of the package and information indicating the delivery address of the package; calculating a redelivery cost required for a redelivery of the package to the delivery address, based on a positional relationship between the position of the package and the delivery address; calculating, for each of the one or more candidates, a receiving agent delivery cost required for a delivery of the package to the delivery address via the candidate, based on the information related to the candidate; selecting, as the receiving agent, the candidate with the receiving agent delivery cost that is less than the redelivery cost; and notifying the receiving agent of a request for acting to receive the package.

General and specific aspects disclosed above may be implemented using a system, a device, a method, an integrated circuit, a computer program, or a computer-readable recording medium such as a recording disk, or any combination of systems, devices, methods, integrated circuits, computer programs, or computer-readable recording media. The computer-readable recording medium includes, for example, a non-volatile recording medium such as a compact disc-read only memory (CD-ROM).

### Advantageous Effects

According to the information processing method and the information processing system in the present disclosure, it is possible to reduce the delivery cost, while delivering a package to the delivery address without any effort from the consignee of the package.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 schematically illustrates an example of a flow of package delivery by a carrier which includes an information processing system according to an embodiment.

FIG. 2 is a block diagram of an example of a configuration of the information processing system according to the embodiment.

FIG. 3 is a block diagram of an example of a configuration of a deliverer terminal according to the embodiment.

FIG. 4 is a block diagram of an example of a configuration of a receiving agent terminal according to the embodiment.

FIG. 5 is a sequence diagram of an example of a flow of package delivery by the carrier which includes the information processing system according to the embodiment.

FIG. 6 is a flowchart of an example of an operation of the receiving agent terminal at the time of receiving agent registration according to the embodiment.

FIG. 7 illustrates a screen showing an example of a display on the receiving agent terminal at the time of receiving agent registration according to the embodiment.

FIG. 8 is a flowchart of an example of an operation of the information processing system at the time of receiving agent registration according to the embodiment.

FIG. 9 is a flowchart of an example of an operation of the information processing system at the time of receipt of a package delivery request according to the embodiment.

FIG. 10 is a flowchart of an example of an operation of the deliverer terminal at the time of detection of absence of a consignee according to the embodiment.

FIG. 11 illustrates a screen showing an example of a display on the deliverer terminal at the time of detection of absence of the consignee according to the embodiment.

FIG. 12 is a flowchart of an example of an information processing method performed by the information processing system according to the embodiment.

FIG. 13 is a flowchart of an example of an operation of the receiving agent terminal at the time of receipt of a query about acting to receiving a package according to the embodiment.

FIG. 14 illustrates a screen showing an example of a display on the receiving agent terminal at the time of receipt of the query about acting to receive the package according to the present embodiment.

FIG. 15 is a flowchart of an example of an operation of the deliverer terminal at the time of receipt of a delivery instruction according to the embodiment.

FIG. 16 illustrates a screen showing an example of a display on the deliverer terminal at the time of receipt of an instruction for delivery to the receiving agent according to the present embodiment.

FIG. 17 illustrates a screen showing an example of a display on the deliverer terminal at the time of receipt of a redelivery instruction according to the embodiment.

FIG. 18 is a flowchart of an example of an operation of the receiving agent terminal at the time of delivery completion according to the embodiment.

FIG. 19 illustrates a screen showing an example of a display on the receiving agent terminal at the time of delivery completion according to the embodiment.

FIG. 20 illustrates a screen showing an example of a display on the receiving agent terminal at the time of assignment of the incentive according to the present embodiment.

FIG. 21 is a flowchart of an example of an operation of the information processing system at the time of receipt of a delivery completion notice according to the embodiment.

FIG. 22 illustrates a method for calculating the incentive.

### DESCRIPTION OF EMBODIMENT

In recent years, in delivery industry, a technique for reducing redelivery which leads to an increased cost has been studied. For example, in the technique disclosed in PTL 1, the consignee designates a receiving agency convenient for the consignee to receive the package so that the consignee can receive the package at the designated receiving agency. However, as described above, there is a problem that effort from the consignee is required.

In view of the above, the inventors of the present disclosure have focused on searching for a receiving agent who acts to receive a package in place of the consignee, and created a following technique which is capable of reducing the delivery cost while delivering the package to the delivery address without any effort from the consignee of the package.

An information processing method according to one aspect of the present disclosure is an information processing method executed by a computer. The information processing method includes, when information indicating absence of a consignee at a delivery address of a package being delivered is obtained: obtaining, for each of one or more candidates for a receiving agent who acts to receive the package, information related to the candidate; obtaining information indicating a position of the package and information indicating the delivery address of the package; calculating a redelivery cost required for a redelivery of the package to the delivery address, based on a positional relationship between the position of the package and the delivery address; calculating, for each of the one or more candidates, a receiving agent delivery cost required for a delivery of the package to the delivery address via the candidate, based on the information related to the candidate; selecting, as the receiving agent, the candidate with the receiving agent delivery cost that is less than the redelivery cost; and notifying the receiving agent of a request for acting to receive the package.

According to the above aspect, when the consignee is present at a predetermined delivery address, such as their home, the consignee is capable of receiving the package at the delivery address. Hence, the consignee does not lose an opportunity for receiving the package at the delivery address. Even when the consignee is absent, the consignee does not need to designate the alternative place for receiving the package. In other words, the consignee does not have to go all the way to the alternative place, such as a receiving agency, to pick up the package. In this way, no effort from the consignee is required. Moreover, when the consignee is absent and when a receiving agent with the receiving agent delivery cost that is less than the redelivery cost is found, the carrier does not need to redeliver the package, leading to a reduction in redelivery cost. Hence, according to the above aspect, the delivery cost can be reduced while delivering the package to the delivery address without any effort from the consignee of the package.

Moreover, it may be that the redelivery cost is calculated by using at least one of a distance between a position where the redelivery of the package starts and the delivery address, or a height of the delivery address.

According to the above aspect, the redelivery cost can be accurately calculated in view of the location of the delivery address.

Moreover, it may be that the information related to the candidate includes a position of the receiving agent, and the receiving agent delivery cost includes a cost calculated by using at least one of a distance between the position of the package and the position of the receiving agent, or a height of the position of the receiving agent.

According to the above aspect, the receiving agent delivery cost can be accurately calculated in view of the position of the receiving agent.

Moreover, it may be that the information related to the candidate includes a compensation for acting to receive the package, and the receiving agent delivery cost includes a cost based on the compensation.

According to the above aspect, the receiving agent delivery cost can be accurately calculated in view of the compensation for acting to receive the package.

Moreover, it may be that an incentive is calculated based on a difference between the redelivery cost and the receiving agent delivery cost and the incentive calculated is assigned to the receiving agent.

According to the above aspect, a receiving agent can be reliably secured by the incentive.

Moreover, it may be that the information indicating the absence of the consignee includes information based on sensor information of a device disposed at the delivery address.

According to the above aspect, it is easy to check the absence of the consignee.

Moreover, it may be that the information related to the candidate includes attribute information of a package receivable by the receiving agent, and the information processing method may further includes: obtaining attribute information of the package being delivered; and narrowing down the one or more candidates by using the attribute information of the package being delivered and the attribute information of the package receivable by the receiving agent.

According to the above aspect, the candidates for the receiving agent can be narrowed down in view of the attribute information of the receivable package, leading to an optimal selection of the receiving agent.

Moreover, it may be that the information processing method further includes: notifying a query to the receiving agent, the query being about whether the receiving agent is capable of acting to receive the package, and the query includes information related to the package.

According to the above aspect, the receiving agent is capable of determining whether to act to receive the package by checking the package related information included in the query.

Moreover, it may be that the information related to the candidate includes schedule information preset by the receiving agent, and the one or more candidates are narrowed down by using the schedule information.

According to the above aspect, the candidate for the receiving agent who is scheduled to be currently unavailable can be excluded.

Moreover, it may be that the information processing method may further include notifying an instruction to deliver the package to the receiving agent.

According to the above aspect, it is possible to make the deliverer or the like delivering the package whose consignee is absent deliver the package to the receiving agent.

An information processing system according to the present disclosure includes: when information indicating absence of a consignee at a delivery address of a package being delivered is obtained, a candidate information obtaining unit which obtains, for one or more candidates for a receiving agent who acts to receive the package, information related to the candidate; a package information obtaining unit which obtains information indicating a position of the package and information indicating the delivery address of the package; a redelivery cost calculator which calculates a redelivery cost required for a redelivery of the package to the delivery address, based on a positional relationship between the position of the package and the delivery address; a receiving agent delivery cost calculator which calculates, for each of the one or more candidates, a receiving agent delivery cost required for a delivery of the package to the delivery address via the candidate, based on the information related to the candidate, a selecting unit which selects, as the receiving agent, the candidate with the receiving agent delivery cost that is less than the redelivery cost, and a notifying unit which notifies the receiving agent of a request for acting to receive the package.

According to the above aspect, it is possible to provide an information processing system capable of reducing the delivery cost, while delivering a package to the delivery address without any effort from the consignee of the package.

General and specific aspects disclosed above may be implemented using a system, a device, a method, an integrated circuit, a computer program, or a computer-readable recording medium such as a recording disk, or any combination of systems, devices, methods, integrated circuits, computer programs, or computer-readable recording media. Examples of the computer-readable recording medium include a non-volatile recording medium such as a CD-ROM. A device or a system may include one or more devices. When the device or the system includes two or more devices, the two or more devices may be disposed in one apparatus, or may be disposed separately in two or more separate apparatuses. In the description and the claims in the present disclosure, the term “system” refers not only to a system including one device, but can also refer to a system including a plurality of devices.

Hereinafter, an information processing method and an information processing system according to the present disclosure will be specifically described with reference to the drawings. The embodiment described below shows a general or specific example. The numerical values, shapes, structural elements, the arrangement and connection of the structural elements, steps, the processing order of the steps etc. shown in the following embodiment are mere examples, and therefore do not intend to limit the present disclosure. Therefore, among the structural elements in the following embodiment, structural elements not recited in any one of the independent claims defining the most generic concept are described as arbitrary structural elements. Note that the drawings are represented schematically and are not necessarily precise illustrations. Additionally, like reference signs indicate like elements in the drawings, and overlapping descriptions thereof are omitted or simplified.

### Embodiment

A configuration of an information processing system according to an embodiment will be described.

In the following embodiment, the information processing system is a server device included, for example, in a carrier. The information processing system is capable of communicating, for example, wirelessly with a deliverer terminal, which is the terminal of a deliverer of the carrier (such as an employee of the carrier), and a receiving agent terminal, which is the terminal of a receiving agent who acts to receive the package being delivered by the deliverer in place of the consignee. For example, the deliverer terminal and the receiving agent terminal each have a function of obtaining information necessary for the information processing system to perform the information processing method, and transmitting the obtained information to the information processing system. The function is implemented by software, such as application, stored in the deliverer terminal and the receiving agent terminal. A configuration of the deliverer terminal and a configuration of the receiving agent terminal will also be described below.

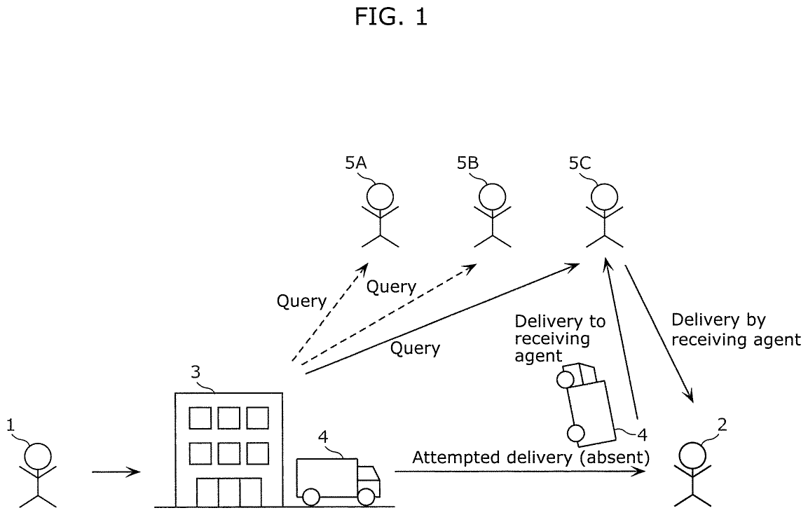

In order to describe the information processing method performed by the information processing system according to the embodiment, first, a flow of package delivery by a carrier which includes the information processing system will be described with reference to FIG. 1.

FIG. 1 schematically illustrates an example of a flow of package delivery by carrier 3 which includes the information processing system according to the embodiment. For example, carrier 3 includes the information processing system, deliverer 4 includes a deliverer terminal (such as a mobile terminal having a delivery related application installed), and receiving agents 5A to 5C each include a receiving agent terminal (such as a mobile terminal having an application for acting to receive a package installed). Receiving agents 5A to 5C are also collectively referred to as receiving agent 5.

Consignor 1 requests carrier 3 for a delivery of a package to be delivered to consignee 2. Deliverer 4 of carrier 3 attempts delivery of the package to consignee 2. When consignee 2 is present at the delivery address (for example, when consignee 2 is at home), the delivery is completed. The delivery address does not have to be the home of consignee 2, but may be, for example, the work place of consignee 2. When consignee 2 is absent, carrier 3 searches for receiving agent 5 who acts to receive the package in place of consignee 2, and sequentially makes a query about acting to receive the package. Assume a case where carrier 3 first makes a query to receiving agent 5A, but is declined by receiving agent 5A, and next makes a query to receiving agent 5B, but is declined by receiving agent 5B, and then makes a query to receiving agent 5C, and is accepted by receiving agent 5C. Deliverer 4 delivers the package to receiving agent 5C who has accepted acting to receive the package. Subsequently, receiving agent 5C delivers the package to consignee 2 in place of carrier 3.

As described above, in the present disclosure, in package delivery, receiving agent 5 may mediate in addition to carrier 3. In other words, when consignee 2 is absent, deliverer 4 may deliver the package to receiving agent 5 in place of consignee 2 without bringing back the package once and redelivering the package.

Next, a configuration of the information processing system included in carrier 3, a configuration of the deliverer terminal included in deliverer 4, and a configuration of the receiving agent terminal included in receiving agent 5 will be described.

First, the information processing system will be described.

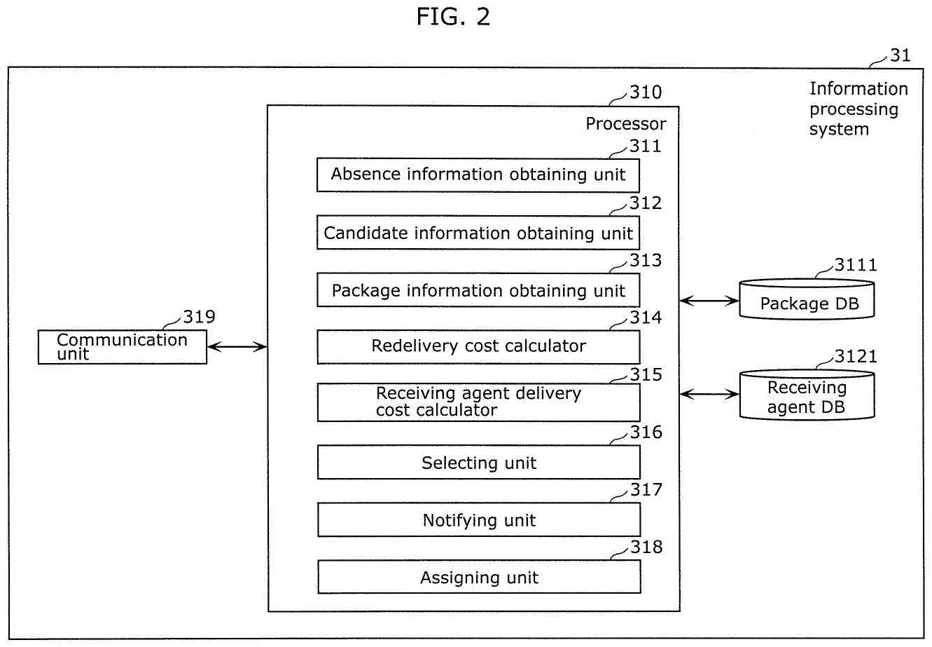

FIG. 2 is a block diagram of an example of a configuration of information processing system 31 according to the embodiment.

Information processing system 31 includes absence information obtaining unit 311, candidate information obtaining unit 312, package information obtaining unit 313, redelivery cost calculator 314, receiving agent delivery cost calculator 315, selecting unit 316, notifying unit 317, and assigning unit 318.

Information processing system 31 is a computer which includes, for example, processor 310 (microprocessor), a memory, and communication unit 319. The memory is, for example, a ROM or a random access memory (RAM), and is capable of storing a program executed by processor 310. The memory also stores package DB 3111 and receiving agent DB 3121. The program, package DB 3111, and receiving agent DB 3121 may be stored in a single memory, or may be stored in different memories. Communication unit 319 is implemented by a communication circuit or the like. Communication unit 319 transmits information to deliverer terminal 41 and receiving agent terminal 51 to be described later, and receives information from deliverer terminal 41 and receiving agent terminal 51. Absence information obtaining unit 311, candidate information obtaining unit 312, package information obtaining unit 313, redelivery cost calculator 314, receiving agent delivery cost calculator 315, selecting unit 316, notifying unit 317, and assigning unit 318, which are included in information processing system 31 as the functional structural elements, are implemented by processor 310 which executes a program stored in the memory.

Package DB 3111 is a database of information of packages delivered by deliverer 4. The package information includes, for example, a package number, the name of the consignor, the address of the consignor, the name of consignee 2, delivery address (specifically, the address of consignee 2), package attribute information (specifically, the size of the package, the weight of the package, or necessity of refrigeration (refrigerated delivery or not)), package delivery request received date and time, preferred delivery date and time, and the current state of the package (such as a state where the package is to be redelivered or a state where the package is to be delivered to receiving agent 5). Registration and update of information in package DB 3111 are performed by, for example, processor 310.

Receiving agent DB 3121 is a database of information related to registered candidates for receiving agent 5. Examples of the information related to the candidates for the receiving agent include receiving agent number, the name of receiving agent 5, the position of receiving agent 5 (specifically, the address of receiving agent 5), attribute information of the package receivable by receiving agent 5 (specifically, the maximum size or weight of the package receivable by receiving agent 5, information as to whether or not the refrigerated package is acceptable), schedule information preset by receiving agent 5 (such as day of week or time of day available for acting to receive the package), compensation for acting to receive the package and information as to whether or not receiving agent 5 is currently at home. Registration and update of information in package DB 3121 are performed by, for example, processor 310.

Absence information obtaining unit 311 obtains information indicating that consignee 2 is absent at the delivery address of the package being delivered by deliverer 4. For example, absence information obtaining unit 311 obtains information indicating the absence of consignee 2 from deliverer terminal 41 held by deliverer 4 via communication unit 319.

When absence information obtaining unit 311 obtains the information indicating that consignee 2 is absent at the delivery address of the package being delivered by deliverer 4, candidate information obtaining unit 312 obtains information related to one or more candidates for receiving agent 5 who acts to receive the package. For example, candidate information obtaining unit 312 obtains information related to the candidates for receiving agent 5 from receiving agent DB 3121.

When absence information obtaining unit 311 obtains the information indicating that consignee 2 is absent at the delivery address of the package being delivered by deliverer 4, package information obtaining unit 313 obtains information indicating the position of the package and information indicating the delivery address of the package. For example, package information obtaining unit 313 obtains the information indicating the position of the package (that is, the current position of deliverer 4 who is delivering the package) from deliverer terminal 41 held by deliverer 4 via communication unit 319. Additionally, for example, package information obtaining unit 313 obtains information indicating the delivery address of the package from package DB 3111.

Redelivery cost calculator 314 calculates the redelivery cost required for the redelivery of the package to the delivery address based on the positional relationship between the position of the package and the delivery address obtained by package information obtaining unit 313. The redelivery cost is, for example, a cost required for deliverer 4 to bring the package back and for the carrier to deliver the package to consignee 2 again, when consignee 2 is absent. The redelivery cost is a cost calculated by using, for example, at least one of the distance between the position where the redelivery of the package starts and the delivery address, or the height of the delivery address. Examples of the position where the redelivery starts include the position of a base, such as package delivery center, and the position of the delivery truck driven by deliverer 4 on the fixed round route. For example, as the distance between the position where the redelivery of the package starts and the delivery address increases, the redelivery cost tends to increase. However, even if the delivery address is positioned far from the base, if the delivery address is on the round route, deliverer 4 passes the round route anyway even when the package is not to be delivered to the delivery address. Hence, the redelivery cost is less likely to increase. Moreover, the height of the delivery address is, for example, floor number or altitude of the delivery address. For example, when the delivery address is on the upper floors, time and labor from deliverer 4 are required for redelivery. This tends to increase the redelivery cost. When the altitude of the delivery address is high, more fuel cost can be required, which tends to increase the redelivery cost. The redelivery cost is a scale calculated by using one of or a combination of the distance between the position where the package redelivery starts and the delivery address or the height of the delivery address. In this manner, by considering the location of the delivery address in calculating the redelivery cost, the redelivery cost can be accurately calculated. The redelivery may be performed by deliverer 4 who is currently delivering the package, or may be performed by another deliverer after deliverer 4 brings back the package to the base.

Receiving agent delivery cost calculator 315 calculates the receiving agent delivery cost required for delivery of the package to the delivery address via a candidate for receiving agent 5, based on the information related to the candidate for receiving agent 5. The receiving agent delivery cost is a cost required for delivering the package to receiving agent 5 when consignee 2 is absent.

The receiving agent delivery cost includes a cost (also referred to as transferring cost) calculated by using, for example, at least one of the distance between the position of the package and the position of receiving agent 5, or the height of the position of receiving agent 5. The position of the package is, for example, the current position of deliverer 4 at the time of detection of absence of consignee 2. The height of the position of receiving agent 5 is, for example, the floor number or the altitude of the position where receiving agent 5 is present. For example, as the distance between the position of the package and the position of receiving agent 5 increases, and as the height of the position of receiving agent 5 increases, the transferring cost tends to increase. In this manner, by considering the position of receiving agent 5 in calculating the receiving agent delivery cost, the receiving agent delivery cost can be accurately calculated.

The receiving agent delivery cost may include a cost (also referred to as a compensation cost) based on the compensation for acting to receive the package by receiving agent 5. The compensation cost may be, for example, money, points available for shopping in a point program (loyalty program), or gifts. In this manner, by including the cost based on the compensation for acting to receive the package in the receiving agent delivery cost, the receiving agent delivery cost can be accurately calculated in view of the compensation for acting to receive the package. Moreover, the receiving agent delivery cost may be a total of the transferring cost and the compensation cost, or may further include other expenses. The receiving agent delivery cost does not have to include the compensation cost. In other words, when receiving agent 5 is a person who acts to receive the package for free, the compensation cost may be zero. As described later in details, the incentive may be assigned to receiving agent 5 in addition to the receiving agent delivery cost.

Selecting unit 316 selects, as receiving agent 5, the candidate for the receiving agent with the receiving agent delivery cost that is less than the redelivery cost. Specifically, selecting unit 316 selects, as receiving agent 5, a candidate for receiving agent 5 with the receiving agent delivery cost that is less than the redelivery cost, and with the condition under which receiving agent 5 is capable of acting to receive the package that is satisfied by the package being delivered. The condition under which receiving agent 5 is capable of acting to receive the package is, for example, included in the information related to the candidate for receiving agent 5. The condition is, specifically, a condition related to the attribute information of the package receivable by receiving agent 5, the schedule information present by receiving agent 5, or information indicating whether or not receiving agent 5 is currently at home. Examples of the condition related to the attribute information of the package receivable by receiving agent 5 include a condition in which the size or the weight of the package being delivered is less than or equal to the maximum size or the maximum weight of the package receivable by receiving agent 5, and a condition in which the package being delivered is not on a refrigerated delivery when the refrigerated delivery is not acceptable for receiving agent 5. Moreover, the condition related to the schedule information preset by receiving agent 5 is, for example, a condition in which the current time is during the receivable time period for receiving agent 5. The condition related to the information indicating that receiving agent 5 is currently at home, is for example, a condition in which receiving agent 5 is currently at home. Selecting unit 316 searches receiving agent DB 3121 for one or more receiving agents 5 who satisfy such conditions.

In this way, selecting unit 316 narrows down the candidates for receiving agent 5 by using the attribute information of the package being delivered obtained by package information obtaining unit 313, the attribute information of the package receivable by the candidates for receiving agent 5 obtained by candidate information obtaining unit 312, and the schedule information preset by receiving agent 5. By narrowing down the candidates for receiving agent 5 by using the attribute information of the package being delivered and the attribute information of the package receivable by the candidates for receiving agent 5, the candidates for receiving agent 5 can be narrowed down in view of the attribute information of the receivable package, so that optimal receiving agent 5 can be selected. Moreover, by narrowing down the candidates for receiving agent 5 by using the schedule information preset by receiving agent 5, candidates for receiving agent 5 who are scheduled to be currently unavailable can be excluded. Selecting unit 316 does not have to select receiving agent 5 who satisfies all the conditions under which receiving agent 5 is capable of acting to receive the package, but may select receiving agent 5 who satisfies at least any of the conditions.

Notifying unit 317 notifies selected receiving agent 5 of a query about whether or not it is possible to act to receive the package. For example, when a plurality of receiving agents 5 are selected, notifying unit 317 notifies a query about whether or not it is possible to act to receive the package to receiving agents 5 sequentially from receiving agent 5 with a lowest receiving agent delivery cost. The query includes information related to the package, for example. Receiving agent 5 is capable of considering whether to act to receive the package by checking the information related to the package included in the query. Notifying unit 317 then notifies a request for acting to receive the package to receiving agent 5 who has replied that it is possible to act to receive the package. For example, notifying unit 317 transmits such a notice to receiving agent terminal via communication unit 319, and receives the reply via communication unit 319. Communication unit 317 also notifies an instruction to deliver the package to receiving agent 5. Specifically, notifying unit 317 transmits the instruction to deliverer terminal 41 via communication unit 319. Accordingly, it is possible to make deliverer 4 deliver the package to receiving agent 5.

Assigning unit 318 calculates the incentive based on the difference between the redelivery cost and the receiving agent delivery cost, and assigns the calculated incentive to receiving agent 5. As described above, other than the receiving agent delivery cost, the incentive may be assigned to receiving agent 5. Assigning unit 318 calculates such an incentive and assigns the calculated incentive to receiving agent 5. Accordingly, the incentive make it easier to secure the receiving agents. Information processing system 31 does not have to include assigning unit 318. In other words, the incentive does not have to be assigned to receiving agent 5.

Next, a configuration of deliverer terminal 41 will be described.

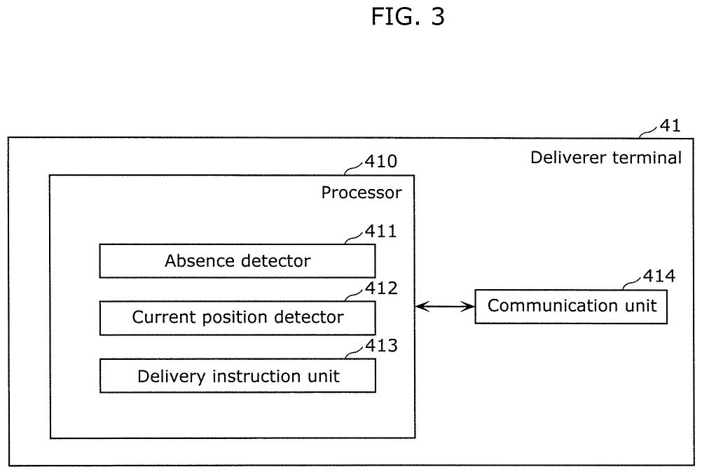

FIG. 3 is a block diagram of an example of a configuration of deliverer terminal 41 according to the embodiment.

Deliverer terminal 41 includes absence detector 411, current position detector 412, and delivery instruction unit 413.

Deliverer terminal 41 is, for example, a computer including processor 410 (microprocessor), a memory, and communication unit 414. The memory is, for example, a ROM or a RAM, and is capable of storing a program executed by processor 410. Communication unit 414 is implemented by a communication circuit or the like. Communication unit 414 transmits information to information processing system 31, and receives information from information processing system 31. Absence detector 411, current position detector 412, and delivery instruction unit 413, which are included in deliverer terminal 41 as the functional structural elements, are implemented by processor 410 which executes a program stored in the memory.

Absence detector 411 detects that consignee 2 of the package being delivered is absent. For example, absence detector 411 may detect absence of consignee 2 by deliverer 4 actually going to consignee 2, finding out the absence of consignee 2, and inputting the absence to deliverer terminal 41. Alternatively, absence detector 411 may detect absence of consignee 2 by receiving the sensor information of a device disposed at the delivery address. Specifically, absence detector 411 may detect absence of consignee 2 by receiving sensor information of a device disposed at the home of consignee 2, such as a sensor which transmits information of lighting in coordination with the switch of the lamp disposed at the delivery address. In recent years, an increased number of internet of things (IoT) devices have been used. Accordingly, absence detector 411 may detect absence of consignee 2 by receiving information indicating absence of consignee 2 from an IoT device disposed at the home of consignee 2. In this manner, by including, in the information which indicates absence of consignee 2, information based on the sensor information of the device disposed at the delivery address, the absence of consignee 2 can be easily checked. Moreover, absence detector 411 may obtain schedule information of consignee 2, and detect absence of consignee 2 by estimating the absence of consignee 2. When absence detector 411 detects the absence of consignee 2, absence detector 411 transmits information indicating the absence of consignee 2 to information processing system 31 via communication unit 414.

When the absence of consignee 2 is detected, current position detector 412 detects the current position of deliverer terminal 41. The current position is detected by, for example, global positioning system (GPS). Deliverer terminal 41 does not have to include a GPS receiver. In this case, current position detector 412 may detect the current position by obtaining the current position of the delivery truck on which deliverer 4 is riding from the GPS receiver included in the delivery truck. This is because the current position of deliverer terminal 41 held by deliverer 4 who is delivering the package is basically the same as the current position of the delivery truck on which deliverer 4 rides for delivery. Current position detector 412 transmits information indicating the detected current position to information processing system 31 via communication unit 414.

When delivery instruction unit 413 receives, from information processing system 31, an instruction to deliver the package to receiving agent 5 or an instruction to redeliver the package, delivery instruction unit 413 instructs deliverer 4 to deliver the package to receiving agent 5 or to redeliver the package. For example, delivery instruction unit 413 displays these instructions on a display or the like included in deliverer terminal 41.

Next, a configuration of receiving agent terminal 51 will be described.

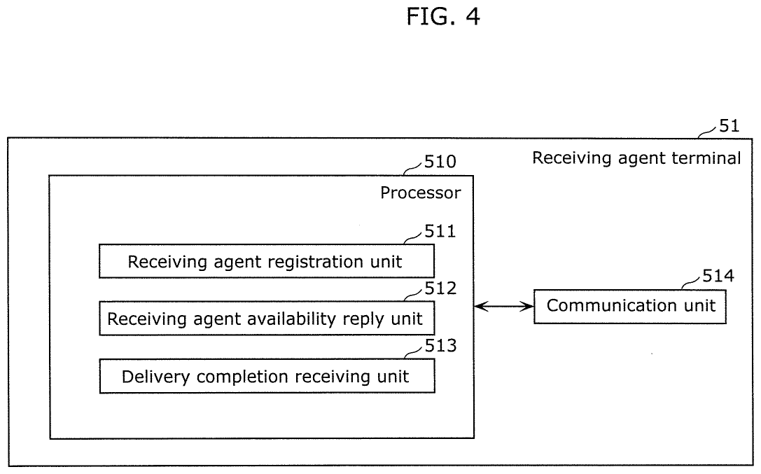

FIG. 4 is a block diagram of an example of a configuration of receiving agent terminal 51 according to the embodiment. Receiving agent terminal 51 includes receiving agent registration unit 511, receiving agent availability reply unit 512, and delivery completion receiving unit 513.

Receiving agent terminal 51 is, for example, a computer including processor 510 (microprocessor), a memory, and communication unit 514. The memory is, for example, a ROM or a RAM, and is capable of storing a program executed by processor 510. Communication unit 514 is implemented by a communication circuit or the like. Communication unit 514 transmits information to information processing system 31, and receives information from information processing system 31. Receiving agent registration unit 511, receiving agent availability reply unit 512, and delivery completion receiving unit 513, which are included in receiving agent terminal 51 as the functional structural elements, are implemented by processor 510 which executes a program stored in the memory.

Receiving agent registration unit 511 receives registration of a person who wants to serve as receiving agent 5. Receiving agent registration unit 511 transmits, to information processing system 31, the details of the registration input by the person who wants to serve as receiving agent 5 via communication unit 514.

When receiving agent reply unit 512 receives a query about acting to receive the package via communication unit 514, receiving agent reply unit 512 receives a reply about whether or not receiving agent 5 accepts acting to receive the package. Receiving agent availability reply unit 512 transmits the details of the reply input by receiving agent 5 to information processing system 31 via communication unit 514.

Delivery completion receiving unit 513 receives an input indicating completion of the delivery of the package which receiving agent 5 have acted to receive to consignee 2. When delivery completion receiving unit 513 receives such an input from receiving agent 5, delivery completion receiving unit 513 transmits the information to information processing system 31 via communication unit 514.

Next, a flow of package delivery via receiving agent 5, and operations of information processing system 31, deliverer terminal 41, and receiving agent terminal 51 will be described.

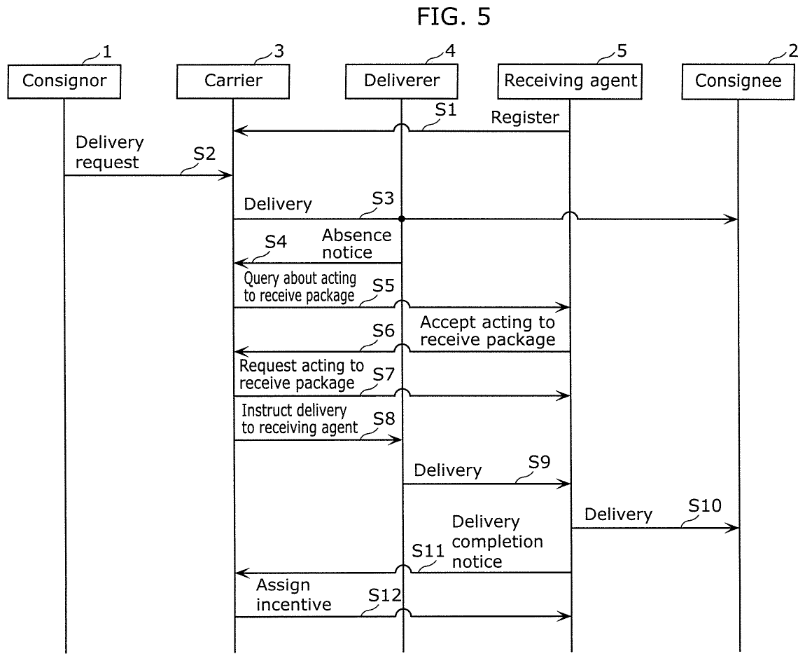

First, the flow of package delivery via receiving agent 5 will be described with reference to FIG. 5.

FIG. 5 is a sequence diagram of an example of the flow of package delivery by carrier 3 which includes information processing system 31 according to the embodiment. As described above, information processing system 31 is included in carrier 3, deliverer terminal 41 is included in (specifically, held by) deliverer 4, and receiving agent terminal 51 is included in (specifically, held by) receiving agent 5.

First, in step S1, receiving agent 5 registers himself or herself to carrier 3 as receiving agent 5 in advance.

In step S2, consignor 1 requests carrier 3 to deliver a package to consignee 2.

In step S3, carrier 3 makes deliverer 4 deliver the package to consignee 2. For example, here, it is assumed that consignee 2 is absent.

In step S4, deliverer 4 detects that consignee 2 is absent, and notifies carrier 3 of the absence. Before deliverer 4 leaves the base for consignee 2, absence of consignee 2 can be detected in advance. However, after the detection of the absence of consignee 2 and before deliverer 4 leaves the base, consignee 2 may come home. Hence, the absence may be detected when deliverer 4 arrives at the deliverer address or immediately before deliverer 4 arrives at the delivery address. Specifically, when deliverer 4 visits a plurality of delivery addresses in a predetermined order, absence may be detected after visiting a given delivery address and leaving for the next delivery address.

In step S5, carrier 3 searches for candidates for receiving agent 5, and makes a query about whether it is possible to act to receive the package sequentially to the candidates for receiving agent 5, for example, starting from the candidate with the lowest receiving agent delivery cost.

In step S6, receiving agent 5 who accepts acting to receive the package replies the acceptance to carrier 3.

When carrier 3 obtains the acceptance from the candidate for receiving agent 5, carrier 3 selects the candidate as receiving agent 5, and ends the query. In step S7, carrier 3 requests selected receiving agent 5 to act to receive the package.

In step S8, carrier 3 instructs deliverer 4 to deliver the package to receiving agent 5, and in step S9, deliverer 4 delivers the package to receiving agent 5.

Subsequently, in step S10, receiving agent 5 delivers the package to consignee 2, and in step S11, receiving agent 5 notifies carrier 3 of the completion of the delivery of the package to consignee 2.

In step S12, carrier 3 assigns the incentive to receiving agent 5.

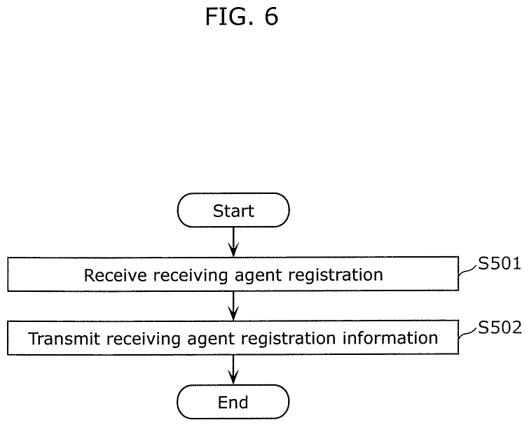

Next, in the above steps, operations of information processing system 31, deliverer terminal 41, and receiving agent terminal 51 in the steps related to information processing system 31, deliverer terminal 41, and receiving agent terminal 51 will be described with reference to FIG. 6 to FIG. 22.

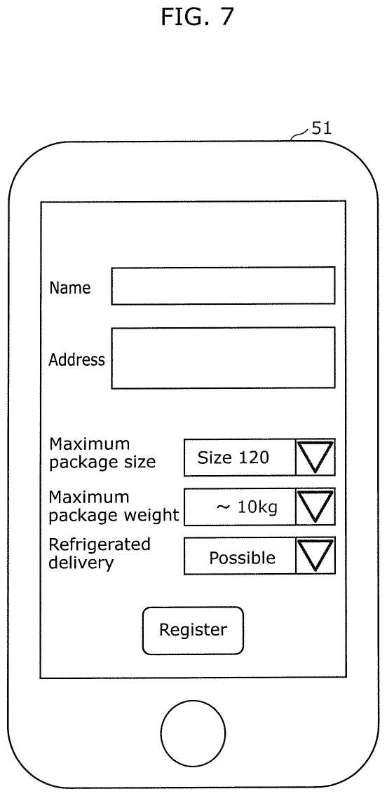

An operation of receiving agent terminal 51 in step S1 in FIG. 5 will be described with reference to FIG. 6 and FIG. 7.

FIG. 6 is a flowchart of an example of an operation of receiving agent terminal 51 at the time of receiving agent registration according to the embodiment.

FIG. 7 illustrates a screen showing an example of a display on receiving agent terminal 51 at the time of receiving agent registration according to the embodiment.

As illustrated in FIG. 6, in step S501, receiving agent registration unit 511 receives an input of receiving agent registration information from a person who wants to serve as receiving agent 5. FIG. 7 illustrates an example of a screen for receiving the input of the receiving agent registration information. FIG. 7 illustrates an example of a screen for receiving an input of name, address, attribute information of the package (maximum package size, maximum package weight, and whether or not refrigerated delivery is acceptable) receivable by the receiving agent as an example of the receiving agent registration information. The maximum package size is selected from among, for example, size 60/size 80/size 120. The maximum package weight is selected from among, for example, 5 kg/10 kg/20 kg. Whether or not the refrigerated delivery is acceptable is selected between possible/not possible.

In step S502, receiving agent registration unit 511 transmits the input receiving agent registration information to information processing system 31 via communication unit 514.

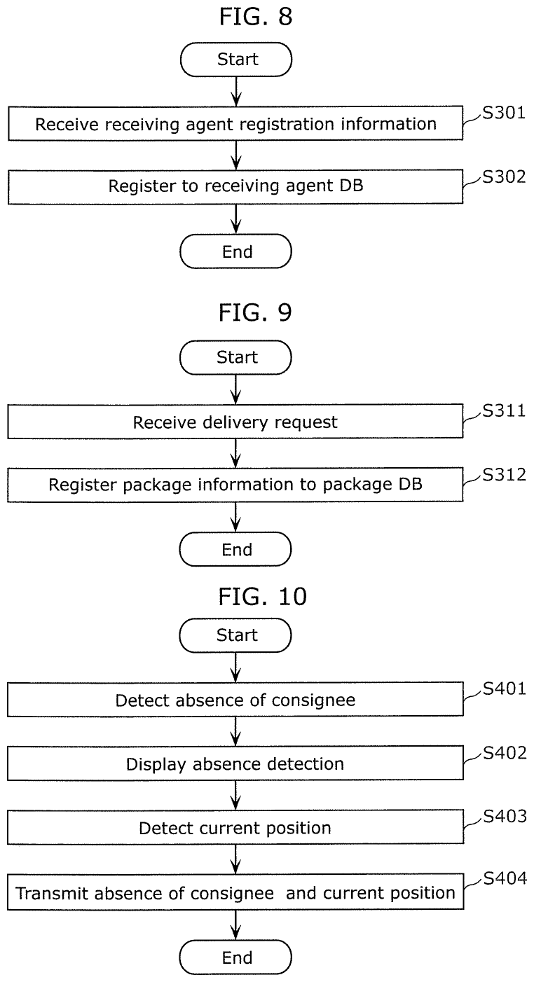

An operation of information processing system 31 in step S1 in FIG. 5 will be described with reference to FIG. 8.

FIG. 8 is a flowchart of an example of an operation of information processing system 31 at the time of receiving agent registration according to the embodiment.

As illustrated in FIG. 8, in step S301, information processing system 31 receives the receiving agent registration information from the person who wants to be new receiving agent 5 using receiving agent terminal 51 via communication unit 319.

In step S302, information processing system 31 registers the received receiving agent registration information to receiving agent DB 3121. In this way, information processing system 31 receives the receiving agent registration information from each person who wants to serve as receiving agent 5, so that a plurality pieces of the receiving agent registration information are registered in receiving agent DB 3121.

Next, an operation of information processing system 31 in step S2 in FIG. 5 will be described with reference to FIG. 9.

FIG. 9 is a flowchart of an example of an operation of information processing system 31 at the time of receipt of a package delivery request according to the embodiment.

As illustrated in FIG. 9, in step S311, information processing system 31 receives a request for package delivery from consignor 1 via communication unit 319. For example, the request includes, as the package information, the name of consignor 1, the address of consignor 1, the name of consignee 2, the address of consignee 2, necessity of refrigeration (refrigerated delivery or not), and the preferred delivery date and time.

In step S312, information processing system 31 registers the package information to package DB 3111 based on the request. Examples of the package information registered in package DB 3111 include package number, the name of consignor 1, the address of consignor 1, the name of consignee 2, the delivery address (specifically, the address of consignee 2), attribute information of the package (specifically, package size, package weight, or necessity of refrigeration (refrigerated delivery or not), delivery request received date and time, and preferred delivery date and time. Deliverer 4 attempts delivery of the package having information registered in package DB 3111 at an appropriate time, but the description thereof is omitted.

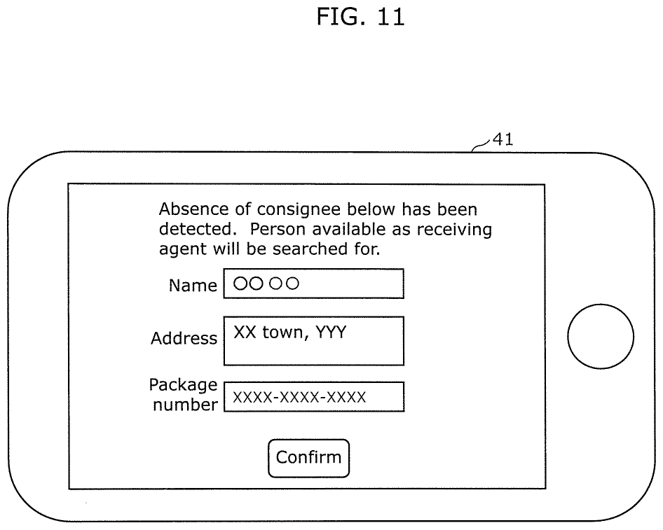

Next, an operation of deliverer terminal 41 in step S4 in FIG. 5 will be described with reference to FIG. 10 and FIG. 11.

FIG. 10 is a flowchart of an example of an operation of deliverer terminal 41 at the time of detection of absence of consignee 2 according to the embodiment.

FIG. 11 illustrates a screen showing an example of a display on deliverer terminal 41 at the time of detection of absence of consignee 2 according to the embodiment.

As illustrated in FIG. 10, in step S401, absence detector 411 detects absence of consignee 2 of the package.

When absence detector 411 detects absence of consignee 2, in step S402, absence detector 411 displays, on the display or the like of deliverer terminal 41, that absence of consignee 2 has been detected. FIG. 11 illustrates an example of the display. As illustrated in FIG. 11, absence of consignee 2, information of consignee 2, the package information, and a message indicating that receiving agent 5 will be searched for are shown.

In step S403, current position detector 412 detects the current position.

In step S404, absence detector 411 and current position detector 412 transmit absence of consignee 2 and the current position to information processing system 31 via communication unit 414.

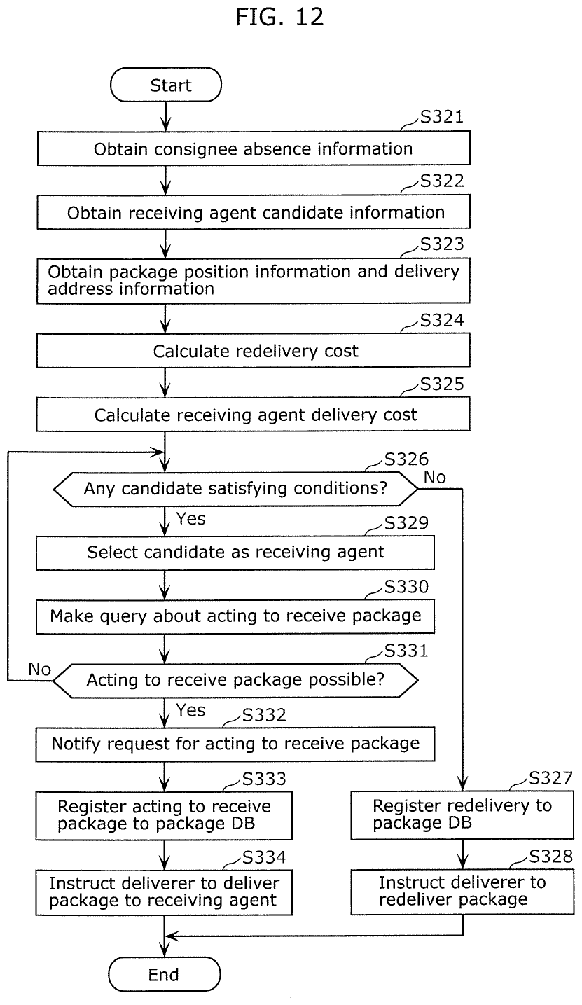

Next, an operation of information processing system 31 in step S5 to step S8 in FIG. 5, that is, an information processing method performed by information processing system 31 will be described with reference to FIG. 12.

FIG. 12 is a flowchart of an example of the information processing method performed by information processing system 31 according to the embodiment.

While deliverer 4 attempts delivery, as illustrated in FIG. 12, in step S321, absence information obtaining unit 311 obtains, from deliverer terminal 41, information indicating absence of consignee 2 at the delivery address of the package being delivered. When the information indicating the absence of consignee 2 is obtained, processing subsequent to step S322 will be performed.

In step S322, candidate information obtaining unit 312 obtains, from receiving agent DB 3121, information related to candidates for receiving agent 5 who acts to receive the package.

In step S323, package information obtaining unit 313 obtains information indicating the position of the package from deliverer terminal 41, and obtains information indicating the delivery address of the package from package DB 3111.

In step S324, redelivery cost calculator 314 calculates the redelivery cost required for the redelivery of the package to the delivery address, based on the positional relationship between the package position and the delivery address.

In step S325, receiving agent delivery cost calculator 315 calculates, based on the information related to the candidates for receiving agent 5, the receiving agent delivery cost required for delivery of the package to the delivery address via each candidate for receiving agent 5. Specifically, receiving agent delivery cost calculator 315 selects one or more candidates for receiving agent 5 who is capable of acting to receive the package based on the attribute information, such as the package size, from among receiving agents 5 registered in receiving agent DB 3121, and calculates the receiving agent delivery cost for each of the selected candidates. Here, before calculating the receiving agent delivery cost, receiving agent delivery cost calculator 315 may further narrow down receiving agents 5 to receiving agents 5 who are within a predetermined positional range from the position of the package obtained by package information obtaining unit 313 (that is, the current position of deliverer terminal 41 or the delivery truck). In other words, receiving agent 5 who is positioned far from the position of the package may be excluded.

In step S326, selecting unit 316 determines if there are any candidates for receiving agent 5 who satisfy the condition. Specifically, selecting unit 316 determines if there are any candidates for receiving agent 5 with the agency delivery cost that is less than the redelivery cost. For example, selecting unit 316 may make the determination by reordering the candidates for receiving agent 5 in an ascending order of the receiving agent delivery cost, that is, from lowest receiving agent delivery cost. Moreover, selecting unit 316 may determine, in addition to the condition about the cost, if there are any candidates who also satisfy the condition about the attribute information of the package receivable by receiving agent 5, schedule information preset by receiving agent 5, or information indicating whether or not receiving agent 5 is currently at home, as described above. As to the information indicating whether or not receiving agent 5 is currently at home, for example, whether or not receiving agent 5 is at home may be determined based on the sensor information of the device disposed at the home or the like of receiving agent 5. When receiving agent 5 is absent, receiving agent 5 may be excluded from the candidates.

In step S326, selecting unit 316 proceeds to step S329 when there are any candidates for receiving agent 5 who satisfy any of the conditions (Yes in step S326), and when not (No in step S326), proceeds to step S327. Although FIG. 5 illustrates the flow of the case where there are candidates for receiving agent 5 who satisfy the conditions, here, the case where there is no candidate for receiving agent 5 who satisfies the conditions will also be described.

In step S327, information processing system 31 registers the package to package DB 3111 as the package to be redelivered. In other words, in package DB 3111, the state of the package is updated to indicate that the package is to be redelivered.

In step S328, notifying unit 317 notifies deliverer terminal 41 of an instruction to redeliver the package via communication unit 319.

In step S329, selecting unit 316 selects, as receiving agent 5, the candidate for receiving agent 5 who satisfies the condition, that is, with the receiving agent delivery cost that is less than the redelivery cost.

In step S330, notifying unit 317 makes a query about whether it is possible to act to receive the package via communication unit 319 sequentially from the candidate for receiving agent 5 with the lowest receiving agent delivery cost among selected receiving agents 5. In other words, in step S331, when notifying unit 317 receives the reply indicating that the candidate for receiving agent 5 is capable of acting to receive the package (Yes in step S331), notifying unit 317 proceeds to step S332. In step S331, when notifying unit 317 receives the reply indicating that the candidate for receiving agent 5 is not capable of acting to receive the package, or receives no reply for a predetermined period (No in step S331), notifying unit 317 performs processing in step S329 to step S331 in a similar manner till when there is no next candidate for receiving agent 5 with a low receiving agent delivery cost or till receiving a reply indicating that it is possible to act to receive the package. The predetermined period is not particularly limited, but, for example, is determined appropriately depending on carrier 3.

In step S332, notifying unit 317 notifies receiving agent 5 of a request for acting to receive the package. Specifically, notifying unit 317 transmits a request for acting to receive the package to receiving agent 5 via communication unit 319.

In step S333, information processing system 31 registers the package to package DB 3111 as the package to be delivered via receiving agent 5. In other words, in package DB 3111, the state of the package is updated to indicate that the package is to be delivered to receiving agent 5.

In step S334, notifying unit 317 notifies deliverer terminal 41 of an instruction to deliver the package to receiving agent 5 via communication unit 319.

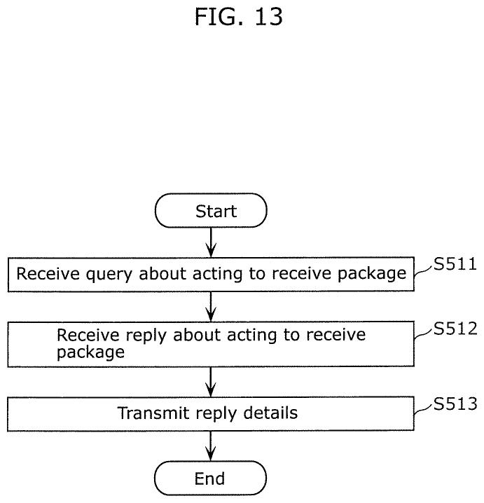

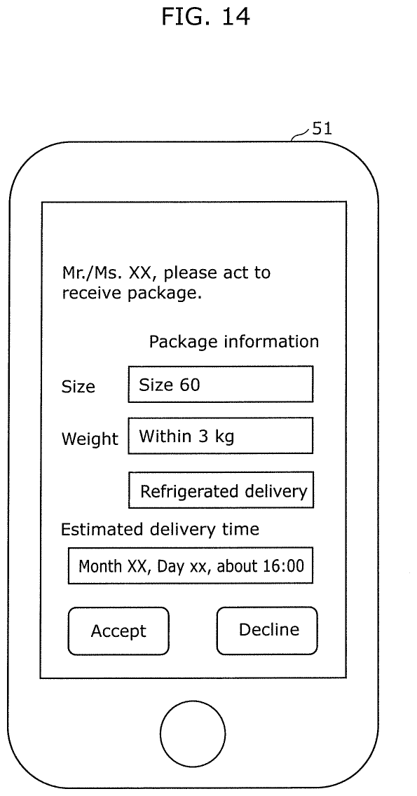

Next, an operation of receiving agent terminal 51 in step S5 and step S6 in FIG. 5 will be described with reference to FIG. 13 and FIG. 14.

FIG. 13 is a flowchart of an example of an operation of receiving agent terminal 51 at the time of receipt of a query about acting to receive the package.

FIG. 14 illustrates a screen showing an example of a display on receiving agent terminal 51 at the time of receipt of a query about acting to receive the package according to the present embodiment.

As illustrated in FIG. 13, in step S511, receiving agent availability reply unit 512 receives a query about whether or not it is possible to act to receive the package from information processing system 31 via communication unit 514.

In step S512, receiving agent availability reply unit 512 displays the details of the query on the display or the like included in receiving agent terminal 51, for example, and receives a reply about whether it is possible to act to receive the package from the candidate for receiving agent 5. FIG. 14 illustrates an example of the display and the screen for receiving the reply. As illustrated in FIG. 14, the package information, and information of the delivery date and time for the receiving agent are displayed, and a reply indicating accept or decline is receivable from the candidate for receiving agent 5.

In step S513, receiving agent availability reply unit 512 transmits the details of the reply to information processing system 31 via communication unit 514.

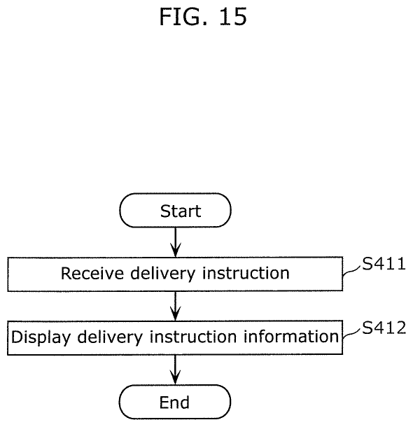

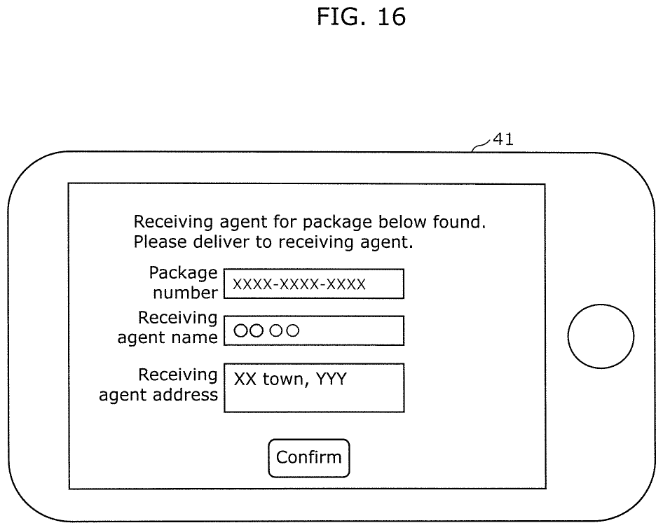

Next, an operation of deliverer terminal 41 in step S8 in FIG. 5 will be described with reference to FIG. 15 and FIG. 16.

FIG. 15 is a flowchart of an example of an operation of deliverer terminal 41 at the time of receipt of a delivery instruction according to the embodiment.

FIG. 16 illustrates a screen showing an example of a display on deliverer terminal 41 at the time of receipt of an instruction for delivery to receiving agent 5 according to the present embodiment.

In step S411, deliverer terminal 41 receives an instruction for delivery from information processing system 31 via communication unit 414. For example, when receiving agent 5 is found, notifying unit 317 notifies deliverer terminal 41 of an instruction to deliver the package to receiving agent 5 via communication unit 319. Accordingly, deliverer terminal 41 receives an instruction to deliver the package to receiving agent 5.

In step S412, in response to the instruction from information processing system 31, delivery instruction unit 413 displays an instruction for delivery to receiving agent 5 on the display or the like included in deliverer terminal 41, for example. FIG. 16 illustrates an example of the display of the instruction for delivery to receiving agent 5. As illustrated in FIG. 16, the package information, the information of receiving agent 5, and the instruction for delivery to receiving agent 5 are displayed.

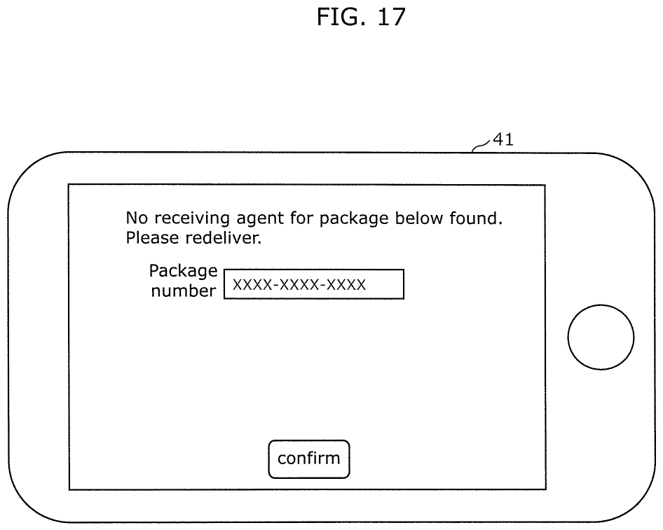

When no receiving agent 5 is found, notifying unit 317 notifies deliverer terminal 41 of an instruction to redeliver the package via communication unit 319. Hence, deliverer terminal 41 receives the instruction to redeliver the package. In this case, in response to the instruction from information processing system 31, delivery instruction unit 413 displays an instruction to redeliver the package on the display or the like included in deliverer terminal 41. FIG. 17 illustrates an example of the display of the instruction to redeliver the package.

FIG. 17 illustrates a screen showing an example of a display on deliverer terminal 41 at the time of receipt of a redelivery instruction according to the embodiment. As illustrated in FIG. 17, the package information and the redelivery instruction are displayed.

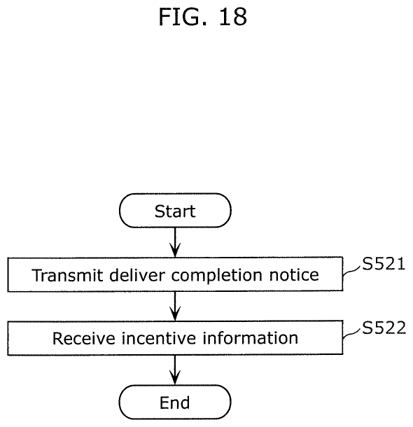

Next, an operation of receiving agent terminal 51 in step S11 and step S12 in FIG. 5 will be described with reference to FIG. 18 to FIG. 20.

FIG. 18 is a flowchart of an example of an operation of receiving agent terminal 51 at the time of delivery completion according to the embodiment.

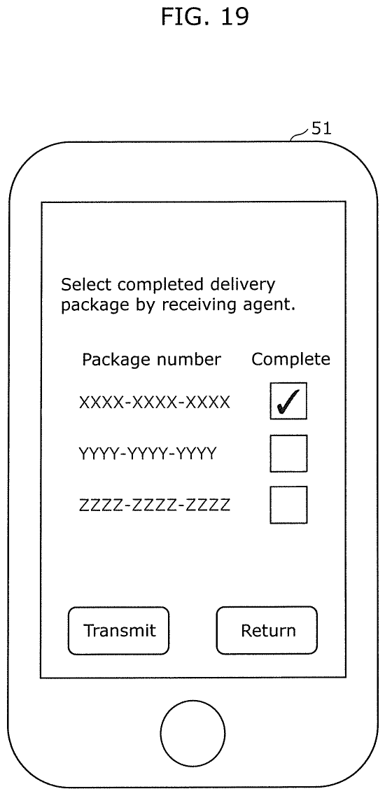

FIG. 19 illustrates a screen showing an example of a display on receiving agent terminal 51 at the time of delivery completion according to the embodiment.

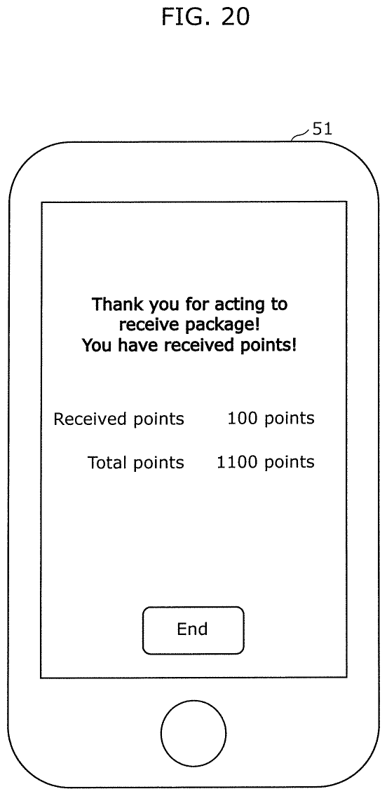

FIG. 20 illustrates a screen showing an example of a display on receiving agent terminal 51 when the incentive is assigned according to the present embodiment.

As illustrated in FIG. 18, in step S521, delivery completion receiving unit 513 receives an input of completed delivery to consignee 2 by receiving agent 5, and transmits delivery completion information to information processing system 31 via communication unit 514. FIG. 19 illustrates an example of the screen for receiving the input. As illustrated in FIG. 19, the completed delivery package is selected by receiving agent 5, and the information is transmitted. In FIG. 19, for example, information of three packages is being displayed because receiving agent 5 is acting to receive the three packages. For example, when receiving agent 5 acts to receive one package, information of the one package is displayed.

In step S522, delivery completion receiving unit 513 receives incentive information from information processing system 31 via communication unit 514, and displays the details on the display or the like included in receiving agent terminal 51. FIG. 20 illustrates an example of the display of the details of the incentive. As illustrated in FIG. 20, the incentive received and total incentives held by receiving agent 5 are displayed.

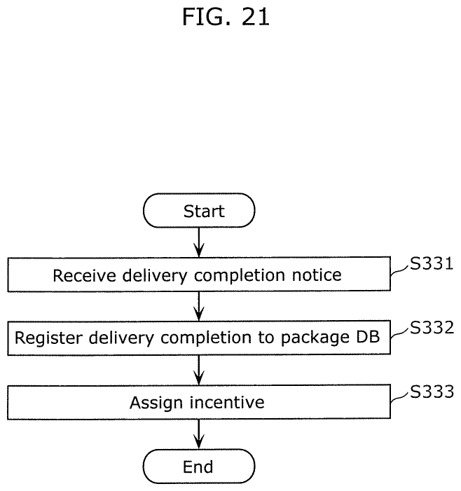

Next, an operation of information processing system 31 in step S11 and step S12 in FIG. 5 will be described with reference to FIG. 21.

FIG. 21 is a flowchart of an example of an operation of information processing system 31 at the time of receipt of a delivery completion notice according to the embodiment.

As illustrated in FIG. 21, in step S331, information processing system 31 receives the notice of completed delivery to receiving agent 2 from receiving agent terminal 51 via communication unit 319.

In step S332, upon receipt of the delivery completion notice, information processing system 31 registers the package delivery completion to package DB 3111. In other words, in package DB 3111, the state of the package is updated to indicate that delivery is completed.

In step S333, assigning unit 318 registers, to receiving agent DB 3121, the incentive to be assigned to receiving agent 5, and transmits the incentive information to receiving agent terminal 51.

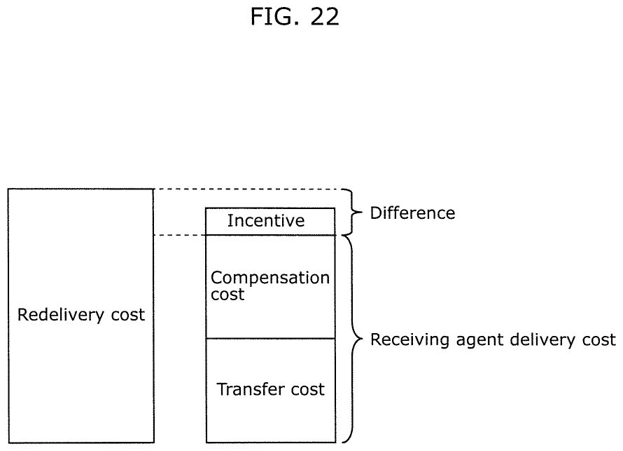

Here, a method for calculating the incentive will be described with reference to FIG. 22.

FIG. 22 illustrates the method for calculating the incentive.

As illustrated in FIG. 22, the incentive is calculated, for example, based on the difference between the redelivery cost and the receiving agent delivery cost (specifically, the sum of the transfer cost and the compensation cost). The incentive make it easier for carrier 3 to secure receiving agent 5 with the cost that is less than the redelivery cost. Moreover, receiving agent 5 is capable of obtaining additional reward that is the incentive. The incentive corresponding to all the difference between the redelivery cost and the receiving agent delivery cost may be assigned, or no incentive may be assigned for acting to receive the package.

As described above, according to the information processing method and information processing system 31 in the present disclosure, when consignee 2 is present at the delivery address, consignee 2 is capable of receiving the package at the delivery address. Accordingly, consignee 2 does not lose the opportunity for receiving the package at the delivery address. Even when then consignee 2 is absent, consignee 2 does not need to designate the alternative place for receiving the package. In other words, consignee 2 does not have to go all the way to the alternative place, such as a receiving agency, to pick up the package. In this way, no effort from consignee 2 is required. Moreover, when consignee 2 is absent and receiving agent 5 with the receiving agent delivery cost that is less than the redelivery cost is found, carrier 3 does not need to redeliver the package, leading to a reduced redelivery cost. Accordingly, the delivery cost can be reduced while delivering the package to the delivery address without any effort from consignee 2 of the package.

### Other Embodiments

Although the information processing method and information processing system 31 according to the present disclosure have been described based on the embodiment, the present disclosure is not limited to the above embodiment. Various modifications of the embodiment as well as embodiments resulting from arbitrary combinations of structural elements of the embodiment that may be conceived by those skilled in the art are intended to be included within the scope of the present disclosure as long as these do not depart from the essence of the present disclosure.

For example, in the above embodiment, information processing system 31 is a server device, but may be a personal computer (PC) or the like provided at carrier 3. The structural elements included in information processing system 31 may be dispersedly disposed in a plurality of servers.

For example, information processing system 31 may be a system which includes deliverer terminal 41 or receiving agent terminal 51.

For example, in the above embodiment, deliverer 4 who is an employee of the carrier delivers a package. However, the present disclosure is not limited to such an example, but a robot or the like of the carrier may deliver a package in place of deliverer 4. In other words, in the above embodiment, deliverer 4 may be replaced with a robot, and the robot may include the functions of deliverer terminal 41. In this case, the display function to deliverer 4 or the like may be unnecessary. For example, in the case where a robot delivers a package, the labor cost would be reduced. Even in this case, the receiving agent delivery cost required for package delivery to the delivery address via receiving agent 5 may be less than the redelivery cost required for redelivery of the package by the robot to the delivery address.

Moreover, the present disclosure can be implemented as a program for causing a computer to execute the steps included in the information processing method. Additionally, the present disclosure can be implemented as a non-transitory computer-readable recording medium, such as a CD-ROM, having such a program stored thereon.

For example, in the case where the present disclosure is implemented by a program (software), each step is executed by the program being executed by using hardware resources such as the CPU of the computer, memory, and input and output circuit. In other words, each step is executed by the CPU obtaining data from the memory, the input and output circuit or the like for calculation, or outputting the calculation result to the memory or the input and output circuit or the like.

The plurality of structural elements included in information processing system 31 according to the embodiment above may be individually implemented as a dedicated circuit or a general-purpose circuit. These structural elements may be implemented as a single circuit or a plurality of circuits.

Moreover, the plurality of structural elements included in information processing system 31 according to the above embodiment may be implemented as a large scale integration (LSI) which is an integrated circuit (IC). The structural elements may be realized as an individual chip, or may be realized as a single chip including part or all of the structural elements. Depending on the degree of integration, LSI may be referred to as system LSI, super LSI, or ultra LSI.

Moreover, the method of circuit integration is not limited to LSI. Integration may be realized with a dedicated circuit or a general-purpose processor. A field programmable gate array (FPGA) or a reconfigurable processor that allows reconfiguration of the connection or configuration of the inner circuit cells of the LSI circuit may be used.

Furthermore, when advancement in semiconductor technology and derivatives of other technologies brings forth a circuit integration technology which replaces LSI, it will be appreciated that such a circuit integration technology may be used to integrate the respective structural elements included in information processing system 31.

Forms obtained by making various modifications to the embodiment that can be conceived by a person skilled in the art as well as forms realized by arbitrarily combining structural elements and functions in the embodiment which are within the scope of the essence of the present disclosure are included in the present disclosure.

Although only an exemplary embodiment of the present invention has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The technique of the present disclosure is useful in a delivery package management system.

1. An information processing method executed by a computer, the information processing method comprising:
when information indicating absence of a consignee at a delivery address of a package being delivered is obtained,
obtaining, for each of one or more candidates for a receiving agent who acts to receive the package, information related to the candidate;
obtaining information indicating a position of the package and information indicating the delivery address of the package;
calculating a redelivery cost required for a redelivery of the package to the delivery address, based on a positional relationship between the position of the package and the delivery address;
calculating, for each of the one or more candidates, a receiving agent delivery cost required for a delivery of the package to the delivery address via the candidate, based on the information related to the candidate;
selecting, as the receiving agent, the candidate with the receiving agent delivery cost that is less than the redelivery cost; and
notifying the receiving agent of a request for acting to receive the package.

2. The information processing method according to claim 1,
wherein the redelivery cost is calculated by using at least one of a distance between a position where the redelivery of the package starts and the delivery address, or a height of the delivery address.

3. The information processing method according to claim 1,
wherein the information related to the candidate includes a position of the receiving agent, and
the receiving agent delivery cost includes a cost calculated by using at least one of a distance between the position of the package and the position of the receiving agent, or a height of the position of the receiving agent.

4. The information processing method according to claim 1,
wherein the information related to the candidate includes a compensation for acting to receive the package, and
the receiving agent delivery cost includes a cost based on the compensation.

5. The information processing method according to claim 1, further comprising:
calculating an incentive based on a difference between the redelivery cost and the receiving agent delivery cost; and
assigning the incentive calculated to the receiving agent.

6. The information processing method according to claim 1,
wherein the information indicating the absence of the consignee includes information based on sensor information of a device disposed at the delivery address.

7. The information processing method according to claim 1, further comprises:
obtaining attribute information of the package being delivered; and
narrowing down the one or more candidates by using the attribute information of the package being delivered and attribute information of a package receivable by the receiving agent,
wherein the information related to the candidate includes the attribute information of the package receivable by the receiving agent.

8. The information processing method according to claim 1, further comprising:
notifying a query to the receiving agent, the query being about whether the receiving agent is capable of acting to receive the package,
wherein the query includes information related to the package.

9. The information processing method according to claim 1,
wherein the information related to the candidate includes schedule information preset by the receiving agent, and
the one or more candidates are narrowed down by using the schedule information.

10. The information processing method according to claim 1, further comprising:
notifying an instruction to deliver the package to the receiving agent.

11. An information processing system, comprising:
when information indicating absence of a consignee at a delivery address of a package being delivered is obtained,
a candidate information obtaining unit which obtains, for one or more candidates for a receiving agent who acts to receive the package, information related to the candidate;
a package information obtaining unit which obtains information indicating a position of the package and information indicating the delivery address of the package;
a redelivery cost calculator which calculates a redelivery cost required for a redelivery of the package to the delivery address, based on a positional relationship between the position of the package and the delivery address;
a receiving agent delivery cost calculator which calculates, for each of the one or more candidates, a receiving agent delivery cost required for a delivery of the package to the delivery address via the candidate, based on the information related to the candidate,
a selecting unit which selects, as the receiving agent, the candidate with the receiving agent delivery cost that is less than the redelivery cost, and
a notifying unit which notifies the receiving agent of a request for acting to receive the package.
